(19) United States
(12) Patent Application Publication
(10) Pub. No.: US 2023/0096394 A1
(43) Pub. Date: Mar. 30, 2023

(54) SCALABLE PROVENANCE DATA DISPLAY FOR DATA PLANE ANALYSIS

(71) Applicant: VMware, Inc., Palo Alto, CA (US)

(72) Inventors: Santhosh Prabhu Muraleedhara Prabhu, Urbana, IL (US); Giri Prashanth Subramanian, Cupertino, CA (US); Atul Jadhav, Pune (IN); Devraj N. Baheti, Akola (IN)

(21) Appl. No.: 17/570,336

(22) Filed: Jan. 6, 2022

(30) Foreign Application Priority Data
Sep. 27, 2021 (IN) 202141043684

(51) Int. Cl. H04L 43/04; H04L 45/00

(52) U.S. Cl. CPC H04L 43/04; H04L 45/26

(57) ABSTRACT

Some embodiments provide a method. The method determines a forwarding path for a packet set by using a data plane model of a network. The method identifies a rule table implementing a step in the forwarding path of the packet set. The method retrieves an indexing file at a scalable storage based on the identified rule table. The indexing file stores rule entries for one or more rule tables of the network. The method retrieves provenance data regarding a rule of the rule table that is applicable to the packet set from the indexing file. The method presents the retrieved provenance information of the identified rule.

### BACKGROUND

Data provenance (or data lineage) includes the data origin, what happens to it, and where it moves over time. Data lineage gives visibility, while greatly simplifying the ability to trace errors back to the root cause in a data analytics process. Data provenance can be used to make the debugging of processing pipelines easier. This necessitates the collection of data regarding data transformations.

### SUMMARY

Some embodiments of the invention provide a data plane analysis tool that scalably provides the provenance information of a forwarding path. The tool constructs a data plane model of a network. The tool determines a forwarding path for a packet by using the data plane model. The tool identifies a rule table implementing a step in the forwarding path of the packet set. The tool retrieves an indexing file at a scalable storage based on the identified rule table, the indexing file storing rule entries for one or more rule tables of the network. The tool identifies a rule of the rule table that is applicable to the packet set from the indexing file. The tool uses a context object associated with the identified rule to retrieve provenance information regarding the identified rule and presents the retrieved provenance information of the identified rule.

In some embodiments, the data plane model is generated based on raw data collected from different physical devices of the network for different rule tables. The data plane model uses symbolic rules (or flow nodes or symbolic sets) to define the behavior of rule tables. A symbolic rule may be amalgamated or merged from different rules in the same or different rule tables. In some embodiments, the data plane model is generated based on data collected by calling an application program interface (API) of a manager of a virtualized network. The data collected is stored as objects in distributed database, and the context object for the identified rule stores an identifier for an object that stores data for the identified rule.

In some embodiments, the tool may receive a query for a correctness check or a search for certain criteria, and the tool responds with one or more forwarding paths in the network that satisfies the search or violates the correctness check. The tool may also receive a query regarding a step in a forwarding path or a packet set in the network. The tool may generate raw provenance data for the step of the forwarding path. The raw provenance data may include an identifier of the rule table, a description of the packet set, an identifier of actions at the rule table, and a time stamp of when the provenance data is fetched from the physical device. The indexing file identifies address locations for rule entries of one or more rule tables. In some embodiments, the process identifies a physical device that implement the rule table. The indexing file is stored at the identified physical device, and the indexing file identifies address locations for one or more rule tables that are implemented at the physical device.

In some embodiments, the tool identifies the rule that is applicable to the packet set by searching through rules of the rule table using the indexing file. In some embodiments, the context object associated with the identified rule is stored in the indexing file or retrieved using the indexing file. The context object includes (i) a device identifier that identifies a physical device implementing the rule table, (ii) a command for retrieving raw data from the physical device, and (iii) an indicator for selecting a section of the raw data that is relevant to the identified rule. In some embodiments, the command in the context object of the identified rule is used to collect the raw data from the identified physical device for the identified rule.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIGS. 1A-C conceptually illustrate a data plane analysis tool that scalably collects and presents network provenance data.

FIG. 2 illustrates an example of a forwarding path that is presented by the data plane analysis tool.

FIGS. 3A-B show a step in a forwarding path and the provenance data associated with the step.

FIG. 4 illustrates an example of a data plane model used for determining a forwarding path.

FIG. 5 illustrates raw data collected from physical devices using show commands.

FIG. 6 conceptually illustrates an example indexing file that stores entries of individual rule tables.

FIG. 7 conceptually illustrates the storage and retrieval of provenance data from different physical devices.

FIG. 8 conceptually illustrates the data plane analysis tool providing a stepwise provenance data to a user that selects a step in a forwarding path.

FIG. 9 conceptually illustrates a context object being used to present provenance data.

FIG. 10 illustrates an example presentation of provenance data for a rule from a distributed firewall in a managed virtualized network.

FIG. 11 conceptually illustrates a process for scalably collecting and presenting provenance data.

FIG. 12 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Data plane analysis tools are designed to formally analyze the data plane state of networks, to enable use cases such as searching how packets are forwarded in the network or check that certain correctness requirements are satisfied. When the results of such search queries or correctness checks are presented to the user, it may be difficult for the user to pinpoint the exact reason why the network behaves in the way that it does. Showing the raw data plane state collected by the tool (provenance information) that caused the result mitigates the problem. While provenance information may be made available to user using naïve techniques, doing so scalably for large networks is a challenge.

Some embodiments provide a method to scalably determine applicable provenance for any behavior reported by a formal network data plane analysis tool. The method includes provenance tracking through the various stages of processing by the data plane analysis tool. The method also includes creation of a stateless API for finding the relevant provenance data. The method also includes an indexed, on-disk storage scheme that facilitates scalable determination of the provenance data.

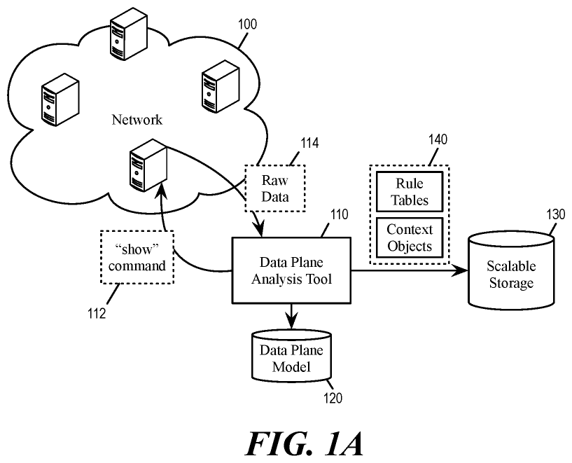

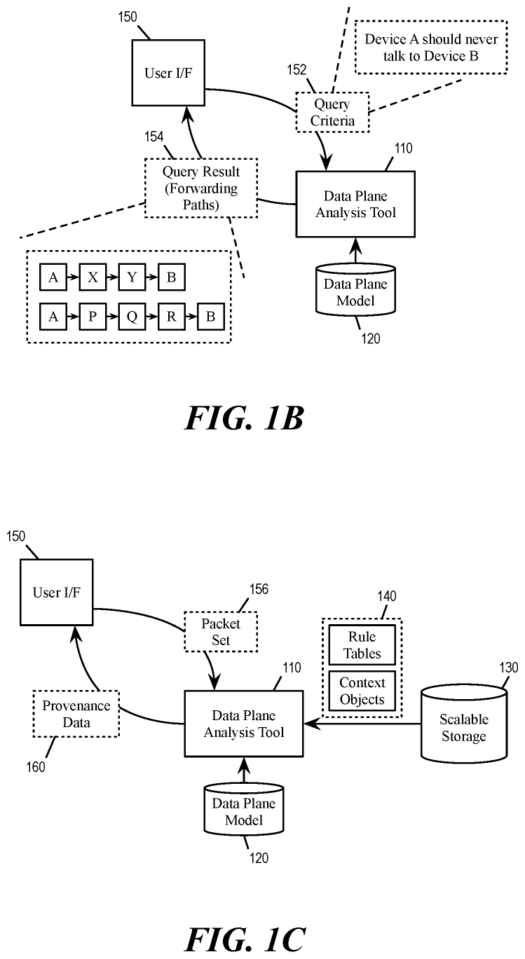

FIGS. 1A-C conceptually illustrate a data plane analysis tool that scalably collects and presents network provenance data. The data plane analysis tool 110 collects raw data 114 from physical devices of the network 100, stores the collected data in a mass storage 130, and uses the stored data to present provenance data for packet forwarding paths in the network 100. The data plane analysis tool 110 may be part of a network assurance and verification feature set of a network insight system, such as vRealize Network Insight® (or vRNI).

The scalable storage 130 refers to one or more data storage devices whose capacity can be scaled to store data collected from the network 100, albeit likely at a cost of higher latency. The scalable storage 130 may include one or more mass storage devices such as hard disks that can store large amounts of data. The scalable storage 130 may include storage devices that are external or remote to the computing device(s) implementing the data plane analysis tool 110. In some embodiments, the scalable storage 130 may include the storage capabilities of the physical devices in the network 100 that are accessible to the data plane analysis tool 110.

FIG. 1A illustrates the data plane analysis tool 110 collecting data from a network 100. The tool 110 sends commands 112 to physical devices of the network 100 to collect raw data 114 from the network 100. The tool 110 uses the collected data 114 to create a simplified data plane model 120. The tool 110 also stores the collected data 114 in mass storage 130. The data being stored may include the content of rule tables arranged in an indexing scheme 140 along with context objects associated with individual rules.

FIG. 1B illustrates the data plane analysis tool receiving a user query 152 and presenting one or more forward paths as query result 154 in response to the query. In some embodiments, the user may have an initial interaction with the tool by issuing query for a correctness check or a search for certain criteria. The tool responds with forwarding paths in the network that satisfies the search or violates the correctness check. When the tool 110 is used to perform a data plane analysis operation, each of the relevant path results that are reported by the tool 110 includes several hops of forwarding packets from one rule table to another. In some embodiments, the data plane analysis tool 110 presents a forwarding path in response to queries for compliance to an intended network policy, or intent specification. In example illustrated in FIG. 1B, the query 152 is for compliance with a policy that states “Device A should never be able to talk to Device B”. In response, the tool presents forwarding paths for packets starting at Device A and ending at Device B to the user, as these are paths in violation of the policy specified in the query. Similarly, for a search query about the flow of HTTP packets, the results may include forwarding paths from the various starting points in the network for HTTP packets.

FIG. 1C illustrates the tool 110 using the created data plane model 120 and the data stored in the mass storage 130 to present provenance data 160. A query 156 for provenance data is made by a user interface 150 for a packet set in the network 100. The user may specify the packet set (in the query 156) based on the forwarding paths presented by the tool 110 in response to the earlier query 152. In response to the query 156, the data plane analysis tool 110 uses the data plane model 120 to determine a forwarding path for the packet set 155. The tool 110 may provide or present detailed provenance information 160 regarding any step in the forwarding path by using the indexing scheme 140 to retrieve detailed information from the mass storage 130.

Instead of storing the original data collected from the network in its unprocessed form in memory (which severely impacts scalability), on-disk storage in the form of indexed files and databases are used to produce a scalable mechanism for providing provenance information for paths reported by the data plane analysis tools. In the example of FIG. 1A-C, the original data (raw data 114) collected from the network 100 is stored in the scalable storage 130 in form of the indexed files 140.

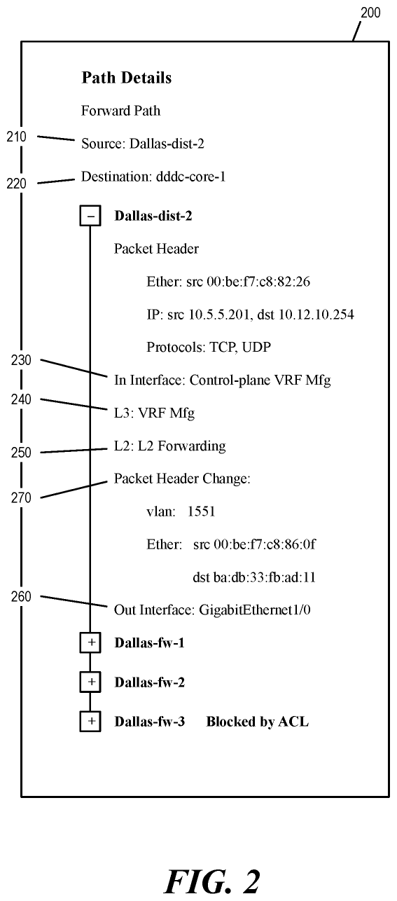

FIG. 2 illustrates an example forwarding path 200 that is presented by the data plane analysis tool 110. The forwarding path 200 is for all packets flowing between two devices 210 and 220. The forwarding path 200 includes several steps, such as In-interface 230, L3 240, L2 250, Out-Interface 260, etc. In some embodiments, each step in the forwarding path 200 represents a rule table. At each rule table, the path specifies the exact set of packets that reach the rule table. In the example of FIG. 2, a same set of packets is forwarded along the entire path 200, from the source to the destination. Though not illustrated in the figure, in some embodiments, a forwarding path may branch out, such that the packet set being forwarded may split into smaller subsets. They may also have fields modified by operations such as Network Address Translation, or in the case of L2 headers, routing. In the example of FIG. 2, the header of the packet set was changed (at indication 270) to have a new vlan identifier and new Ethernet source and destination addresses. In some embodiments, the data plane analysis tool 110 shows the user, for each forwarding path, at each rule table, the exact fragment of provenance information that is relevant to the packet set reaching that rule table on that path.

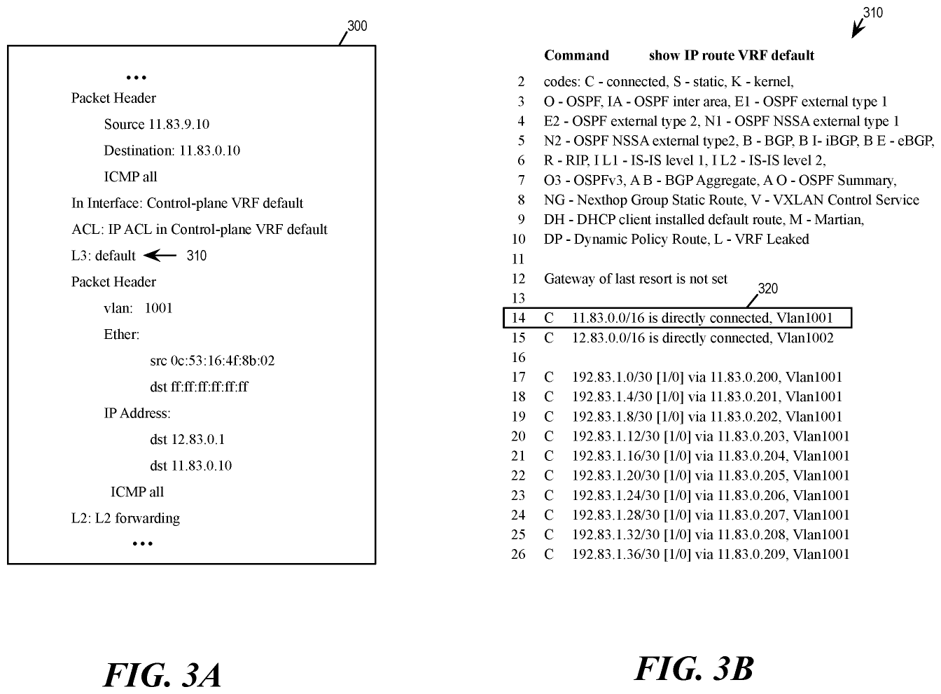

FIGS. 3A-B show a step in a forwarding path and the provenance data associated with the step. FIG. 3A illustrates a fragment of a forwarding path 300. FIG. 3B illustrates the provenance data of a L3 table 310 in the path 300. The L3 rule table 310 matches on the IP destination (11.83.0.10) with the entries in the FIB table, to decide where to send the packet. In this case a rule 320 in the rule table 310 matches on 11.83.0.0/16, and the packet is forwarded out of the interface Vlan1001.

The data plane model 120 is a formal model of the network 100 that the tool 110 constructs or updates periodically, based on data that is collected from the network 100. In some embodiments, the raw data 114 collected from the network 100 are converted into a compact representation that requires less memory and computation to store and manipulate.

In some embodiments, the data plane model 120 models the network 100 as a collection of rule tables which forward packets to each other and ultimately to end points that lie outside the network. The forwarding behavior of a rule table on a path is fully determined by the packet set that arrives there. At each rule table, the model defines symbolic equivalence classes with their associated actions. Entities such as physical and virtual switches, routers, etc., are not directly represented in the model, even though one could identify them as close-knit groups of rule tables.

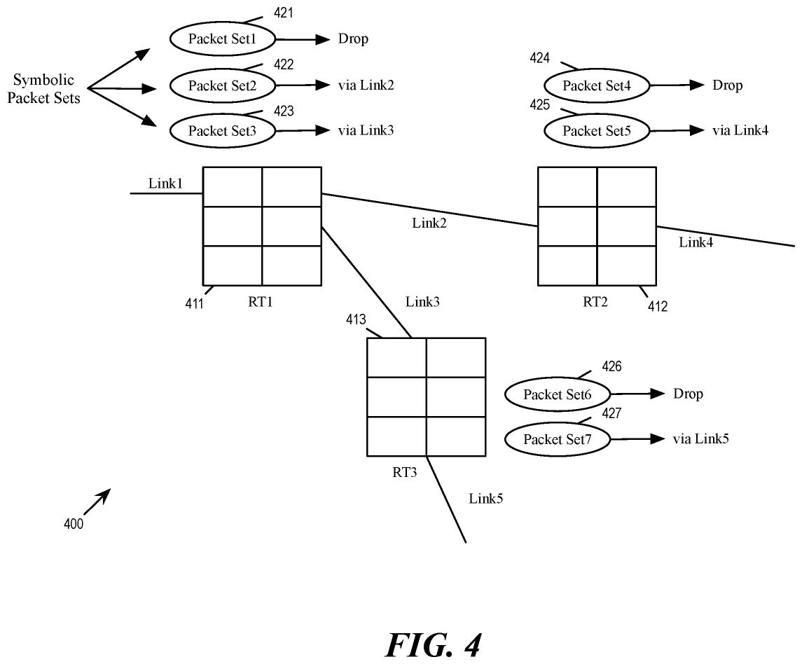

FIG. 4 illustrates an example of a data plane model 400 used for determining a forwarding path. In the data plane model 400, packets are forwarded from one rule table to another according to the entries of the individual rule tables. In some embodiments, the behavior of each rule table is described by (or associated with) one or more flow nodes. A flow node, which is also referred to as a symbolic set, represents one unique set of actions that the rule table performs to packets that it processes. Each flow node specifies a set of packets and an action to be taken on the specified set of packets. In some embodiments, a flow node is an encapsulation of the rule table identifier, a set of actions, and the set of packets that undergo those actions at that rule table. In some embodiments, the insight system derives the flow nodes of a rule table from the content of the entries of the rule table.

The figure illustrates portions of a data plane model 400 that includes three rule tables: RT1 (rule table 411), RT2 (rule table 412), and RT3 (rule table 413). Packets arriving at RT1 411 at Link1 may be forwarded via Link2, forwarded via Link3, or dropped. Packets arriving at RT2 412 may be forwarded via Link4 or dropped. Packets arriving at RT3 413 may be forwarded via Link5 or dropped.

For the data plane model 400, the behaviors of the rule tables 411-413 are specified by flow nodes. Each flow node specifies an action for a packet set, and the rule table performs the specified action (e.g., forwarded via a particular link or dropped) on packets that are classified as belonging to that packet set. In the example of FIG. 4, the behavior of RT1 411 is described by flow nodes 421-423. The flow node 421 specifies that packets classified as packet set 1 are dropped. The flow node 422 specifies that packets classified as packet set 2 are forwarded via Link2 (to RT2 412). The flow node 423 specifies that packets classified as packet set 3 are forwarded via Link3. The behavior of RT2 412 is described by flow nodes 424-425. The flow node 424 specifies that packets classified as packet set 4 are dropped. The flow node 425 specifies that packets classified as packet set 5 are forwarded via Link4. The behavior of RT3 413 is described by flow nodes 426-427. The flow node 426 specifies that packets classified as packet set 6 are dropped. The flow node 427 specifies that packets classified as packet set 7 are forwarded via Link5.

A forwarding table may have many flow nodes, one for each type of forwarding behavior, along with the respective packet sets that are handled that way. The sets of packets are termed as equivalence classes, since each set represents a unique type of processing that applies exactly to the packets in that set. For example, an access control list (ACL) rule table may have two flow nodes, or two symbolic sets—one with a deny action, and the set of all packets that are denied by the ACL, and the other with an allow action, and the set of all packets that are allowed. Data plane analysis tools may compress the information into two distinct symbolic sets—All packets that are allowed, and all packets that are denied.

When a user performs a query, the results are determined on the basis of the compressed model rather than the original data plane, and hence, the user cannot usually see the exact piece of collected information that was the root cause of the network's behavior. For instance, in the data plane model, an ACL table may have a symbolic set or flow node that represents both a first rule that says “deny ICMP packets between host 10.0.1.2 to host 30.0.1.2” and a second rule that says “deny ICMP packets between host 10.0.2.2 to host 20.0.1.2”. When ICMP packets between 10.0.1.2 and 30.0.1.2 are dropped, the fact that the drop is caused by the first rule in the list will be lost, thanks to the compression step that merges rules together. As a result, the user cannot pinpoint the exact reason why a result is being reported by the tool. The user will benefit if the tool could present the user with not just the forwarding behavior, but also the exact set of raw, unprocessed data that led to this result, as provenance information.

Showing provenance information requires keeping track of provenance right from the point the data is collected from the network. In some embodiments, the data plane analysis tool (or the network insight system) collects data from physical devices in two different ways—(i) by logging into them and running commands such as show running-config, show ip route etc., or (ii) by invoking APIs in a network virtualization manager (e.g., VMware NSX®).

In order to obtain detailed provenance data for any step of a forwarding path, the data plane analysis tool 110 collects raw data from physical devices or appliances in the network 100. The tool 110 may log into those physical devices to issue show commands and obtain output data of those commands. The tool 110 collects the output data from those physical devices and stores them in the scalable storage 130. In some embodiments, the collected data are stored as encrypted JSON files.

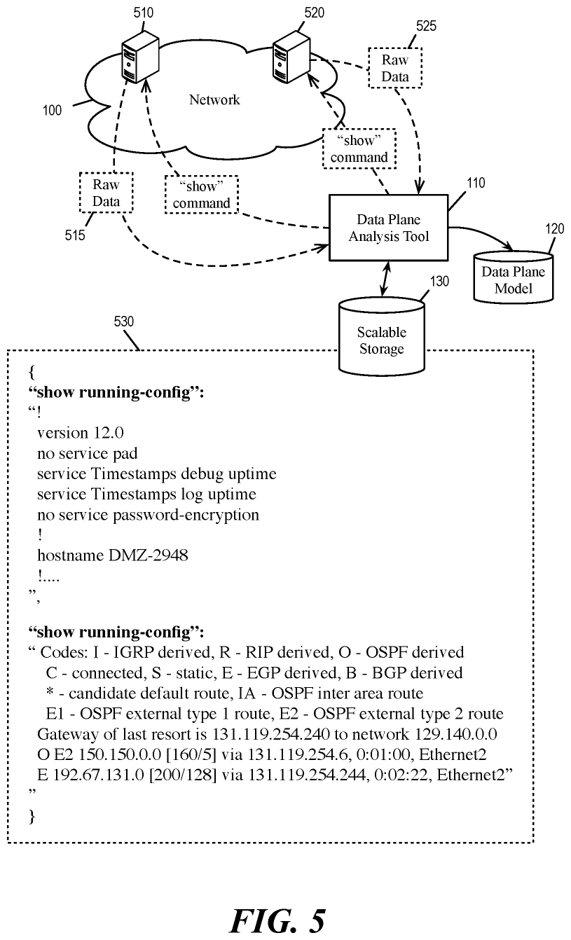

FIG. 5 illustrates raw data collected from physical devices using show commands. The data plane analysis tool 110 issues the show command “show running-config” to a first physical device 510 and obtains raw data 515. The tool 110 issues the show command “show running-config” to a second physical device 520 and obtains raw data 525. The raw data 515 and 525 are stored at the scalable storage 130 as parts of a raw provenance data file 530 (a JSON file). In the raw provenance data file 530, each key is a show command, and the corresponding values or content is the result of the show command. In some embodiments, the file 530 is stored in a location that is uniquely defined by the tool 110 with a timestamp of when the data was collected.

The data plane analysis tool 110 converts the collected data 515 and 525 into the data plane model 120. In some embodiments, the process of creating the data plane model includes two stages—device modeling and symbolic model building. In the device modeling stage, the data plane analysis tool 110 parses and processes the raw information collected from physical devices (e.g., raw data 515 and 525 from physical devices 510 and 520) into rule tables. At the end of the device modeling stage, each rule table contains rule entries, which determine how the packets should be forwarded. Each rule entry has a relative priority, a match and an action—the match decides which packets the rule processes, and the action determines the exact manner of processing. In some embodiments, each rule entry has a provenance field that stores device ID, show command, line number in the command output. Rule tables roughly correspond to tables that process packets in the real network, such as MAC tables, forwarding tables, ACL tables etc. In the symbolic model building stage, the data plane analysis tool 110 converts the rule tables created by the device modeling stage into a data plane model (e.g., the data plane model 400 of FIG. 4), in which the behavior of each rule table is specified by flow nodes or symbolic sets.

Converting individual rule entries from the device model stage into a data plane model during the symbolic model building stage involves merging rule entries with identical actions and discarding the context information. The context data is instead retained in the separate indexing file 140 stored in the scalable storage 130. In some embodiments, each rule entry in a rule table created during the device modeling stage has provenance information. The provenance information of a rule entry is stored as a corresponding context object. The context object of a rule entry has the following information: (1) device ID, (2) relevant show command, and (3) position (e.g., line number) of interest in the output of the show command that is relevant to the rule.

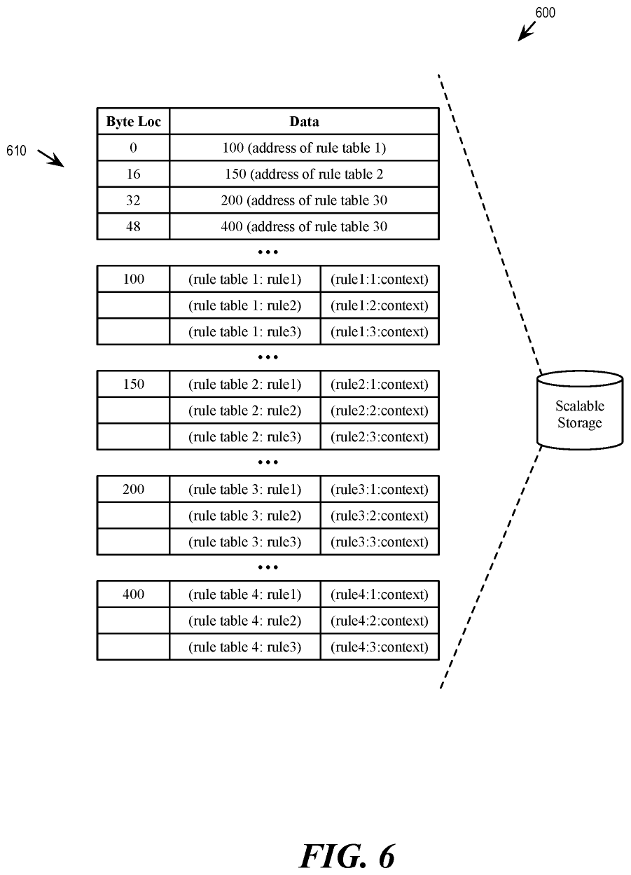

In the indexing file, the original rules from the rule tables are written to disk (the scalable storage) one rule table at a time. A map is stored at the beginning to indicate the location in the file where the data for each rule table begins. The data of each rule table includes entries that contains corresponding rules objects and context objects. FIG. 6 conceptually illustrates an example indexing file that stores entries of individual rule tables. As illustrated, an indexing file 600 is stored in the scalable storage 130. (The indexing file 600 is an example of the indexing file 140.) The indexing file 600 includes a mapping portion 610 at the beginning. The mapping portion 610 specifies the starting addresses of several rule tables (e.g., address 100 for rule tables 1, address 150 for rule table 2, etc.). After the mapping portion 610, the indexing file 600 stores the entries of rule table 1 starting at address 100, the entries of rule table 2 starting at address 150, the entries of rule table 3 starting at address 200, etc. Each rule entry of each rule table is stored with a context object for that rule entry.

When creating the data plane model 120, some flow nodes or symbolic sets are created by merging multiple rule entries from multiple different rule tables. For example, the data plane analysis tool 110 may combine rule entries from different tables (e.g., a FIB and an ARP table) to form one flow node or symbolic set for the data plane model when performing device modeling. Such a flow node may be derived from multiple rule entries and therefore associated with multiple context objects (e.g., a first context object for the FIB entry and a second context object for the ARP entry). In some embodiments, the data plane analysis tool 110 may obtain provenance information from multiple different rule tables for such a flow node. In some embodiments, the data plane model 120 includes a mapping between rule tables and physical devices. Thus, given a rule table identifier, the corresponding raw data file for provenance information from a physical device can be located and retrieved (e.g., from the scalable storage 130).

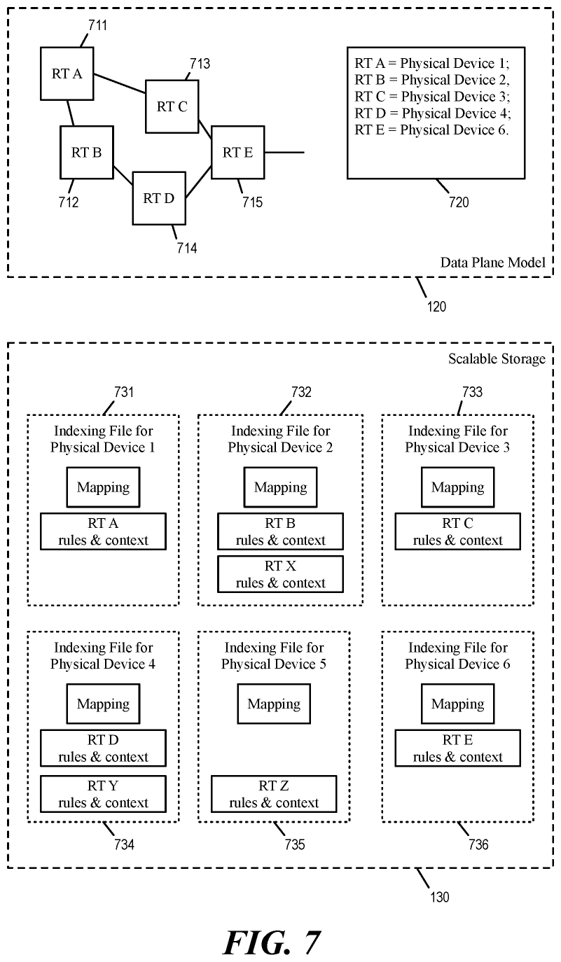

FIG. 7 conceptually illustrates the storage and the retrieval of provenance data from different physical devices. As illustrated, the data plane model 120 includes rule tables 711-715 (RT A through E). The behavior of each rule table is specified by flow nodes or symbolic sets. The data plane model 120 also includes a mapping 720 between rule tables and physical devices. According to the mapping 720, the rule table RT A 711 has provenance information from physical device 1, the rule table RT B 712 has provenance information from physical device 2, the rule table RT C 713 has provenance information from physical device 3, rule table RT D 714 has provenance information from physical device 4, and rule table RT E 715 has provenance information from physical device 6. Thus, for example, when a query is made for provenance data of RT D 714 (e.g., when a user selects a step in a forwarding path that includes the rule table RT D 714), the data plane analysis tool 110 uses the mapping 720 to identify the provenance data from physical device 4 as being relevant.

The figure also illustrates the storage of the provenance data of different physical devices. As illustrated, the scalable storage 130 stores provenance data from different physical devices as indexing files 731-736 for physical devices 1, 2, 3, 4, 5, and 6, respectively. (The index files 731-736 are examples of the indexing file 140). As described by reference to FIG. 6 above, each indexing file stores the actual rule entries and corresponding context objects of different rule tables. An indexing file of a physical device stores the rule entries and corresponding context objects of the rule tables that are implemented by that physical device. For example, when the data plane analysis tool 110 uses the mapping 720 to determine that the physical device 4 has relevant provenance data, the indexing files 734 is searched for matching rule entries, and the context objects of the matching rule entries are used to retrieve and display the provenance data.

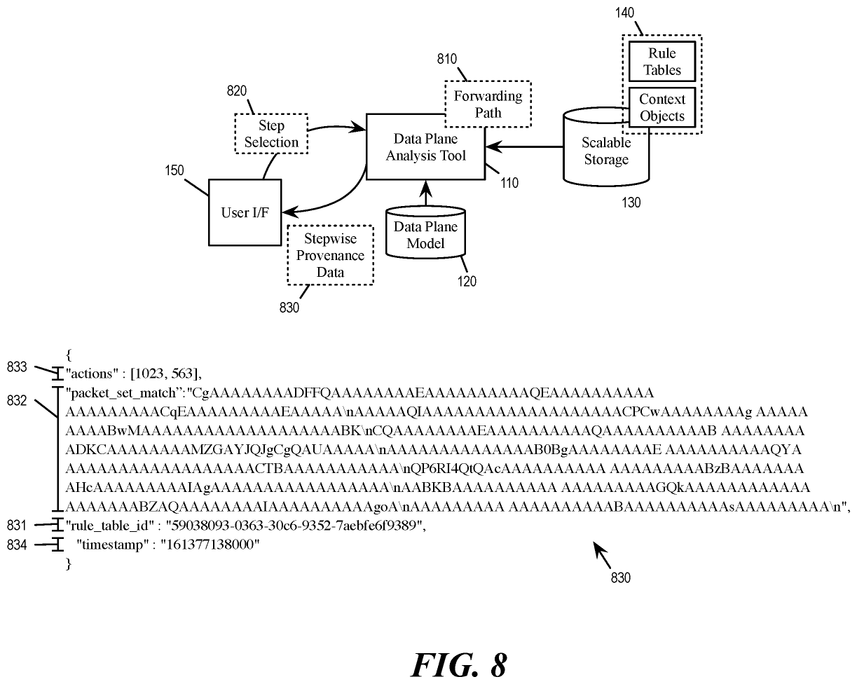

The data plane analysis tool 110 uses the created data plane model 120 to answer user queries about the forwarding behavior of the network 100. As previously discussed, the results for these queries are forwarding paths, each of which including several steps of forwarding packet sets from one rule table to another. The user of the tool 110 can choose any step in a forwarding path that is of interest to them by clicking on it, and the tool 110 responds with the relevant provenance data by using the data plane model 120 and, the stored indexing files, and the raw provenance data (e.g., in raw provenance data file 530) stored in the scalable storage 130. In some embodiments, the forwarding paths are sent to the user, and for each step, a raw data section of the step is provided by the tool 110 (e.g., as a JSON). The stepwise raw data section contains the following information: (i) the ID of the rule table at that step (or rule_table_id), (ii) the symbolic packet set (or packet_set_match), (iii) IDs of the actions at the rule table that are relevant to that step (or actions), (iv) timestamp for which the provenance data is fetched. FIG. 8 conceptually illustrates the data plane analysis tool 110 providing a stepwise provenance data to a user that selects a step in a forwarding path.

In the example, the data plane analysis tool 110 has used the data plane model 120 to determine a forwarding path 810 for a packet set. The data plane analysis tool 110 then receives a query 820 (step selection) for provenance data for a step in the forwarding path 810. The data plane analysis tool 110 uses the data plane model 120 and the indexing files 140 in the scalable storage 130 to locate the relevant rule entries, context objects in order, and the raw provenance data to generate a stepwise provenance data 830 for the selected step. The figure also illustrates an example of the contents of the stepwise provenance data 830 being provided to the user interface 150 (in form of a JSON object) so the user can view the provenance information of that step. As illustrated, the provenance data 830 includes a rule_table_id field 831, a packet_set_match field 832 (in base-64 encoded serialization), an actions field 833, and a time stamp field 834.

When the user interface 150 provides the step selection 820 for the forwarding path 810 to view the provenance information, the above raw data section is sent back to the backend of the data plane analysis tool 110. The raw data section (e.g., of the stepwise provenance data 830) contains the necessary information for the tool 110 to determine which exact piece of information to display as the stepwise provenance. The rule_table_id field 831 is used to identify the relevant rule table(s) and their location in the storage system. The packet_set_match field 832 specifies the matching condition of the relevant rule for the forwarding step (i.e., the match condition of the flow node or symbolic set in the data plane model 120). The action field 833 specifies the action of the relevant rule. The timestamp field 834 specifies the time that the data plane model 120 was generated or updated. In some embodiments, the actions field 833 is used to distinguish between multiple possible behaviors at the same step. For example, if ECMP is configured for the step, a same packet may be forwarded along one of many paths. The actions field 833 is used to identify which of the possible next hops is relevant to the path that the user 150 is looking at.

In some embodiments, the backend of the data plane analysis tool 110 uses the raw data section or the stepwise provenance data 830 to identify the exact rules that are relevant to the step. The tool 110 identifies a data plane model having the desired timestamp and loads it into memory. The tool 110 then uses the data plane model to identify the physical device corresponding to rule_table_id. The tool 110 also locates the corresponding indexing file based on the rule_table_id. The mapping portion of the indexing file is used to read the rules from the rule table identified by rule_table_id. The tool 110 then checks each rule from the rule table in priority order for overlaps against the packet_set_match, to identify the rules that are applicable to the packet set. In some embodiments, the tool 110 keeps only actions that require performing actions in the actions list while discarding others. The tool 110 then obtains a list of rules in the form they were constructed by the device modeling phase.

Not all rules may be relevant to the processing of a packet set. For example, a packet set that corresponds to IP destination 192.168.10.0/30 may be dropped by an ACL, but different subsets of the packet set may be dropped due to different rules, for example four packet dropping rules that correspond to IP destinations 192.168.10.0, 192.168.10.1, 192.168.10.2 and 192.168.10.3. The data plane analysis tool 110 may determine which exact subsets of the packet set are processed by which exact rule (rule entries in rule tables).

As mentioned earlier, each rule entry has a context object associated with it (while a flow node/symbolic set may be derived from multiple rule entries and therefore be associated with multiple context objects). A context object has fields for indicating the exact line of collected data that resulted in its creation. In some embodiments, the data plane analysis tool 110 uses context objects to find and display the exact block of provenance information relevant to a given rule or step. Specifically, the tool uses the device ID in the context object and the timestamp to open the correct raw provenance data file (e.g., the JSON file 530 of FIG. 5). From this raw provenance data file, the tool 110 uses the command in the context object as a key to identify the relevant output. The tool 110 then breaks the identified relevant output into lines and uses a position of interest indicated by the context object to return a block of a predefined size containing the position of interest. For example, the tool 110 may return a maximum of 25 lines, 12 lines before the line of interest, and 12 lines after the line of interest. The tool 110 may also show different subsets of the packet set that are applicable to each rule.

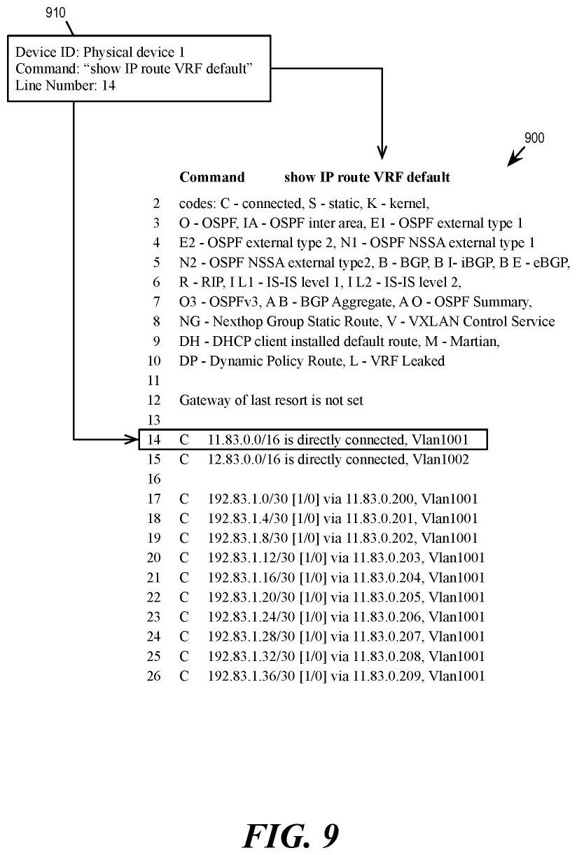

FIG. 9 conceptually illustrates a context object being used to present provenance data. The figure illustrates a block of a raw provenance data 900 that is generated by issuing a show command “show IP route VRF default” to a physical device (“physical device 1”) in the network. As the raw provenance data 900 is used to generate the data plane model and the indexing files, the data plane analysis tool 110 identifies line 14 as being relevant to a particular rule entry of a rule table. The tool 110 correspondingly creates a context object 910 for the particular rule entry.

When a user selects a step in a forwarding path for provenance information that involves the particular rule, the data plane analysis tool 110 retrieves the context object 910. Based on the device ID of the context object 910, the tool 110 retrieves raw provenance data from “physical device 1” and uses the command “show IP route VRF default” as a key to locate the corresponding provenance data in the raw provenance data 900. Based on the position of interest (line number) indication of the context object 910, the tool 110 presents the provenance data around line 14 and highlights line 14.

The method described thus far is based on provenance data retrieved from physical devices, and whose data is collected in the form of simple text. In some embodiments, provenance data can also be collected from virtual network components. These virtual network components are implemented by host machines running virtualization software such as VMware's ESX®, with the virtual network being managed by a network virtualization management software such as VMware's NSX®. For example, the data plane analysis tool 110 may collect data using API calls to the NSX manager. Instead of storing the collected data in a file, the tool 110 stores this information in a distributed database as network virtualization management objects, with identifiers for each object. This is done not just for provenance collection and presentation, but also for other features of a network insight system that includes the data plane analysis tool 110.

During the device modeling phase, instead of processing the raw textual data, the data plane analysis tool 110 retrieves these management objects from the distributed database and creates rule tables and rules. A context object that is associated with a rule holds the unique object IDs of the management objects that caused the respective rule of the context object to be created. In some embodiments, the “device ID” field of the context object is used to hold the unique object IDs of the management objects. For example, for a L3 rule table in a distributed router, each rule holds the ID for a corresponding entry in a NSX routing table, which is stored in the database. The symbolic modeling phase remains unchanged, including using an indexing scheme to store the content of rule tables in indexing files.

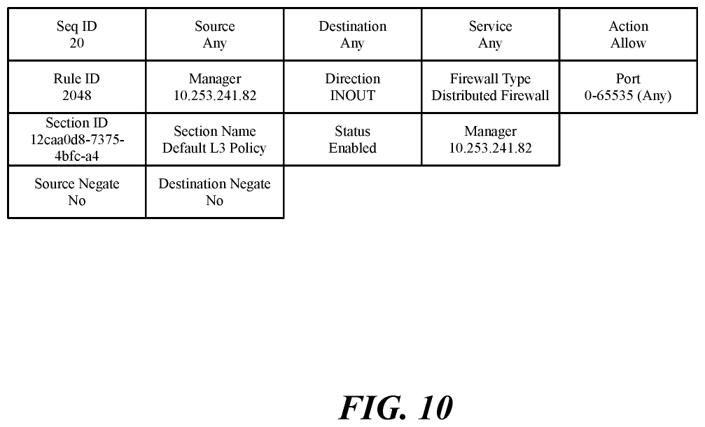

When a user requests to see the provenance data for a particular forwarding step in a managed virtualized network, the data plane analysis tool 110 identifies the relevant rules for the step. However, there is no JSON file from which to obtain the provenance information. Instead, the tool 110 uses the object IDs in the context objects of the rules to fetch management objects from the database, then presents the management objects in a meaningful way to the user. FIG. 10 illustrates an example presentation of provenance data for a rule from a distributed firewall in a managed virtualized network.

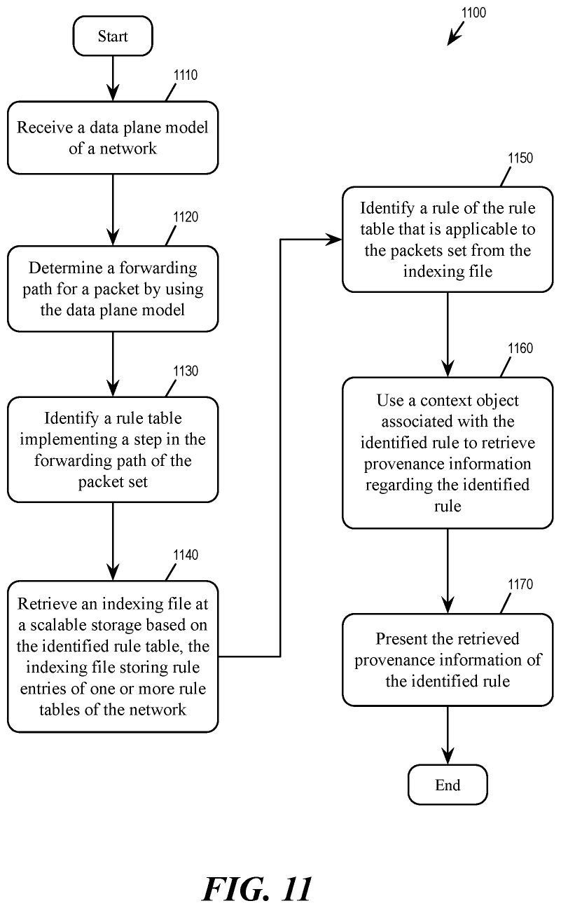

For some embodiments, FIG. 11 conceptually illustrates a process 1100 for scalably collecting and presenting provenance data. In some embodiments, one or more processing units (e.g., processor) of a computing device implementing the data plane analysis tool 110 perform the process 1100 by executing instructions stored in a computer-readable medium.

In some embodiments, the process 1100 starts when the data plane analysis tool 110 receives or generates (at 1110) a data plane model (symbolic packet set/flow nodes) of a network. The data plane model is generated based on raw data collected from different physical devices of the network for different rule tables. The data plane model uses symbolic rules (or flow nodes or symbolic sets) to define the behavior of rule tables. A symbolic rule may be amalgamated or merged from different rules in the same or different rule tables. In some embodiments, the data plane model is generated based on data collected by calling an application program interface (API) of a manager of a virtualized network. The data collected is stored as management objects in distributed routers in the virtualized network, and the context object for the identified rule stores an identifier for a management object that stores data for the identified rule.

The process 1100 determines (at 1120) a forwarding path for a packet by using the data plane model. The process 1110 identifies (at 1130) a rule table implementing a step in the forwarding path of the packet set. The process 1100 also generates raw provenance data for the step of the forwarding path, the step including the rule table. The raw provenance data includes an identifier of the rule table, a description of the packet set, an identifier of actions at the rule table, and a time stamp of when the provenance data is fetched from the physical device.

The process 1100 retrieves (at 1140) an indexing file (stored) at a scalable storage based on the identified rule table, the indexing file storing rule entries for one or more rule tables of the network. The indexing file identifies address locations for rule entries of one or more rule tables. In some embodiments, the process 1100 identifies a physical device that implements the rule table. The indexing file is stored at the identified physical device, and the indexing file identifies address locations for one or more rule tables that are implemented at the physical device.

The process 1100 identifies (at 1150) a (highest priority) rule of the rule table that is applicable to the packet set from the indexing file. In some embodiments, the process 1100 identifies the rule that is applicable to the packet set by searching through rules of the rule table using the indexing file. The process 1100 uses (at 1160) a context object associated with the identified rule to retrieve provenance information regarding the identified rule. In some embodiments, the context object associated with the identified rule is stored in the indexing file or retrieved using the indexing file. The context object includes (i) a device identifier that identifies a physical device implementing the rule table, (ii) a command for retrieving raw data from the physical device, and (iii) an indicator for selecting a section of the raw data that is relevant to the identified rule. In some embodiments, the command in the context object of the identified rule is used to collect the raw data from the identified physical device for the identified rule.

The process 1100 presents (at 1170) the retrieved provenance information of the identified rule. The process 1100 then ends.

In some embodiments, the data path analysis tool 110 captures data from virtual network entities that are implemented by host machines running virtualization software, serving as a virtual network forwarding engine. Such a virtual network forwarding engine is also known as a managed forwarding element (MFE), or hypervisor. Virtualization software allows a computing device to host a set of virtual machines (VMs) or data compute nodes (DCNs) as well as to perform packet-forwarding operations (including L2 switching and L3 routing operations). These computing devices are therefore also referred to as host machines. The packet forwarding operations of the virtualization software are managed and controlled by a set of central controllers, and therefore the virtualization software is also referred to as a managed software forwarding element (MSFE) in some embodiments. In some embodiments, the MSFE performs its packet forwarding operations for one or more logical forwarding elements as the virtualization software of the host machine operates local instantiations of the logical forwarding elements as physical forwarding elements. Some of these physical forwarding elements are managed physical routing elements (MPREs) for performing L3 routing operations for a logical routing element (LRE), some of these physical forwarding elements are managed physical switching elements (MPSEs) for performing L2 switching operations for a logical switching element (LSE).

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

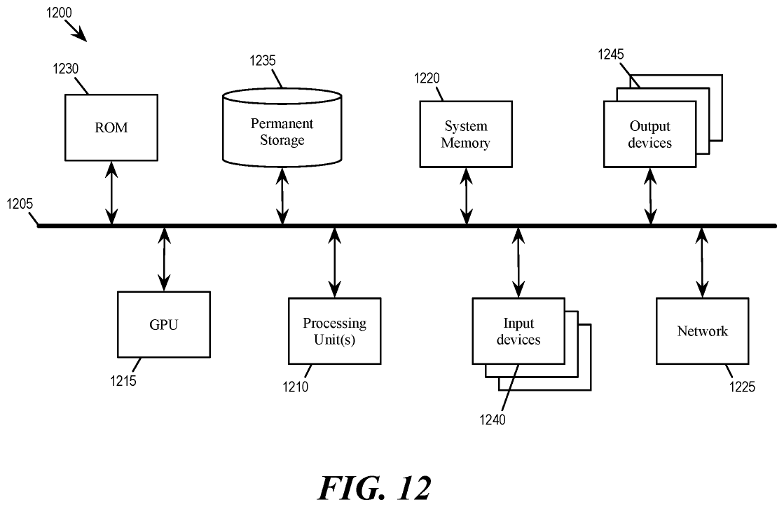

FIG. 12 conceptually illustrates a computer system 1200 with which some embodiments of the invention are implemented. The computer system 1200 can be used to implement any of the above-described hosts, controllers, and managers. As such, it can be used to execute any of the above-described processes. This computer system 1200 includes various types of non-transitory machine-readable media and interfaces for various other types of machine-readable media. Computer system 1200 includes a bus 1205, processing unit(s) 1210, a system memory 1220, a read-only memory 1230, a permanent storage device 1235, input devices 1240, and output devices 1245.

The bus 1205 collectively represents all system, peripheral, and chipset buses that communicatively connect the numerous internal devices of the computer system 1200. For instance, the bus 1205 communicatively connects the processing unit(s) 1210 with the read-only memory 1230, the system memory 1220, and the permanent storage device 1235.

From these various memory units, the processing unit(s) 1210 retrieve instructions to execute and data to process in order to execute the processes of the invention. The processing unit(s) 1210 may be a single processor or a multi-core processor in different embodiments. The read-only-memory (ROM) 1230 stores static data and instructions that are needed by the processing unit(s) 1210 and other modules of the computer system 1200. The permanent storage device 1235, on the other hand, is a read-and-write memory device. This device 1235 is a non-volatile memory unit that stores instructions and data even when the computer system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device 1235. Like the permanent storage device 1235, the system memory 1220 is a read-and-write memory device. However, unlike storage device 1235, the system memory 1220 is a volatile read-and-write memory, such as random access memory. The system memory 1220 stores some of the instructions and data that the processor needs at runtime. In some embodiments, the invention's processes are stored in the system memory 1220, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices 1240 enable the user to communicate information and select commands to the computer system 1200. The input devices 1240 include alphanumeric keyboards and pointing devices (also called “cursor control devices”). The output devices 1245 display images generated by the computer system 1200. The output devices 1245 include printers and display devices, such as cathode ray tubes (CRT) or liquid crystal displays (LCD). Some embodiments include devices such as a touchscreen that function as both input and output devices 1240 and 1245.

Finally, as shown in FIG. 12, bus 1205 also couples computer system 1200 to a network 1225 through a network adapter (not shown). In this manner, the computer 1200 can be a part of a network of computers (such as a local area network (“LAN”), a wide area network (“WAN”), or an Intranet, or a network of networks, such as the Internet. Any or all components of computer system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Several embodiments described above include various pieces of data in the overlay encapsulation headers. One of ordinary skill will realize that other embodiments might not use the encapsulation headers to relay all of this data.

Also, several figures conceptually illustrate processes of some embodiments of the invention. In other embodiments, the specific operations of these processes may not be performed in the exact order shown and described in these figures. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method comprising:
determining a forwarding path for a packet set by using a data plane model of a network;
identifying a rule table implementing a step in the forwarding path of the packet set;
retrieving an indexing file at a scalable storage based on the identified rule table, the indexing file storing rule entries for one or more rule tables of the network;
retrieving provenance data regarding a rule of the rule table that is applicable to the packet set from the indexing file; and
presenting the retrieved provenance information of the identified rule.

2. The method of claim 1, wherein the indexing file identifies address locations for a plurality of rule tables.

3. The method of claim 2, wherein identifying the rule that is applicable to the packet set comprises searching through rules of the rule table using the indexing file.

4. The method of claim 1, wherein the provenance information is retrieved by using a context object that is associated with the identified rule, the context object comprising:
a device identifier that identifies a physical device implementing the rule table;
a command for retrieving raw data from the physical device; and
an indicator for selecting a section of the raw data that is relevant to the identified rule.

5. The method of claim 4, wherein the context object is retrieved using the indexing file.

6. The method of claim 4, wherein the command in the context object of the identified rule is used to collect the raw data from the identified physical device for the identified rule.

7. The method of claim 1, further comprising generating raw provenance data for the step of the forwarding path, the step comprising the rule table, the raw provenance data comprising an identifier of the rule table, a description of the packet set, an identifier of actions at the rule table, and a time stamp of when the provenance data is fetched from the physical device.

8. The method of claim 1, wherein the data plane model is generated based on raw data collected from different physical devices of the network for different rule tables.

9. The method of claim 8, wherein the data plane model comprises symbolic rules that are amalgamated from different rules.

10. The method of claim 1 further comprising identifying a physical device that implements the rule table, wherein the indexing file is stored at the identified physical device, wherein the indexing file identifies address locations for one or more rule tables that are implemented at the physical device.

11. The method of claim 1, wherein the data plane model is generated based on data collected by calling an application program interface (API) of a manager of a virtualized network.

12. The method of claim 11, wherein the data collected is stored as objects in a distributed database, wherein the context object for the identified rule stores an identifier for an object that stores data for the identified rule.

13. A non-transitory machine-readable medium storing a program for execution by at least one processing unit, the program comprising sets of instructions for:
determining a forwarding path for a packet set by using a data plane model of a network;
identifying a rule table implementing a step in the forwarding path of the packet set;
retrieving an indexing file at a scalable storage based on the identified rule table, the indexing file storing rule entries for one or more rule tables of the network;
retrieving provenance data regarding a rule of the rule table that is applicable to the packet set from the indexing file; and
presenting the retrieved provenance information of the identified rule.

14. The non-transitory machine-readable medium of claim 13, wherein the indexing file identifies address locations for a plurality of rule tables, wherein identifying the rule that is applicable to the packet set comprises searching through rules of the rule table using the indexing file.

15. The non-transitory machine-readable medium of claim 13, wherein the provenance information is retrieved by using a context object that is associated with the identified rule and is retrieved using the indexing file, the context object comprising:
a device identifier that identifies a physical device implementing the rule table;
a command for retrieving raw data from the physical device for the identified rule; and
an indicator for selecting a section of the raw data that is relevant to the identified rule.

16. The non-transitory machine-readable medium of claim 13, wherein the program further comprises a set of instructions for generating raw provenance data for the step of the forwarding path, the step comprising the rule table, the raw provenance data comprising an identifier of the rule table, a description of the packet set, an identifier of actions at the rule table, and a time stamp of when the provenance data is fetched from the physical device.

17. The non-transitory machine-readable medium of claim 13, wherein the data plane model is generated based on raw data collected from different physical devices of the network for different rule tables, wherein the data plane model comprises symbolic rules that are amalgamated from different rules.

18. The non-transitory machine-readable medium of claim 13, wherein the program further comprises a set of instructions for identifying a physical device that implements the rule table, wherein the indexing file is stored at the identified physical device, wherein the indexing file identifies address locations for one or more rule tables that are implemented at the physical device.

19. The non-transitory machine-readable medium of claim 13, wherein the data plane model is generated based on data collected by calling an application program interface (API) of a manager of a virtualized network, wherein the data collected is stored as objects in a distributed database, wherein the context object for the identified rule stores an identifier for an object that stores data for the identified rule.

20. An electronic device comprising:
a set of one or more processing units; and
a non-transitory machine-readable medium storing a program for execution by at least one of the processing units, the program comprising sets of instructions for:
determining a forwarding path for a packet set by using a data plane model of a network;
identifying a rule table implementing a step in the forwarding path of the packet set;
retrieving an indexing file at a scalable storage based on the identified rule table, the indexing file storing rule entries for one or more rule tables of the network;
retrieving provenance data regarding a rule of the rule table that is applicable to the packet set from the indexing file; and
presenting the retrieved provenance information of the identified rule.
